(19) United States
(12) Patent Application Publication
(10) Pub. No.: US 2018/0067429 A1
(43) Pub. Date: Mar. 8, 2018

(54) FIXING BELT AND FIXING APPARATUS

(71) Applicants: KABUSHIKI KAISHA TOSHIBA, Tokyo (JP); TOSHIBA TEC KABUSHIKI KAISHA, Tokyo (JP)

(72) Inventor: Kazuhiko Kikuchi, Yokohama Kanagawa (JP)

(21) Appl. No.: 15/255,296

(22) Filed: Sep. 2, 2016

(51) Int. Cl. G03G 15/20

(52) U.S. Cl. CPC G03G 15/2057

(57) ABSTRACT

In accordance with an embodiment, a fixing belt comprises a non-magnetic metal layer and a magnetic metal layer, wherein a thickness of the magnetic metal layer is larger than that of the non-magnetic metal layer.

### FIELD

Embodiments described herein relate generally to a fixing belt and a fixing apparatus.

### BACKGROUND

Conventionally, there is an image forming apparatus such as a multi-function peripheral (hereinafter, referred to as an “MFP”) and a printer. The image forming apparatus is equipped with a fixing apparatus. The fixing apparatus heats a conductive layer of a belt through an electromagnetic induction heating system (hereinafter, referred to as an “IH system”). At the time of forming an image, the fixing apparatus fixes a toner image on an image receiving medium through the heat of the belt. The conductive layer of the belt generates the heat through induced current.

The fixing apparatus reduces an amount of energy consumption without heating the belt in a case in which the fixing apparatus is in a dormant state in which a fixing processing is not executed. The fixing apparatus reduces heat capacity of the belt to shorten the time required for the fixing apparatus to transform from the dormant state to the start of forming an image. The fixing apparatus is equipped with a magnetic material so as to compensate the lack of calorific value of the belt. The magnetic material concentrates magnetic flux at the time of electromagnetic induction heating to increase the calorific value of the belt.

For example, the magnetic material is a magnetic shunt alloy. There is known a technology for forming a part of the conductive layer with a non-magnetic metal. However, if the conductive layer formed by the non-magnetic metal in the fixing apparatus is thin, then the temperature of the magnetic shunt alloy is undesirably increased. As a result, the belt may not be sufficiently heated in some cases. There is a problem that such a fixing apparatus cannot shorten the time required to transform from the dormant state to the start of forming an image.

### DESCRIPTION OF THE DRAWINGS

FIG. 1 is a side view illustrating an image forming apparatus 10 according to a first embodiment;

FIG. 2 is a side view containing an electromagnetic induction heating coil unit 52 and a control block of a main body control circuit 101;

FIG. 3 is a view illustrating a magnetic path by magnetic flux of a main coil 56 to a belt 50 and a heat generation assistance plate 69;

FIG. 4 is a block diagram illustrating control of an IH coil unit 52 according to the first embodiment;

FIG. 5 is a diagram illustrating the configuration of the belt 50;

FIG. 6 is a diagram illustrating a relation of calorific value with respect to thickness of a protective layer and thickness of a heat generation layer;

FIG. 7 is a diagram illustrating the time of starting of a fixing apparatus or a sleep state;

FIG. 8 is diagram illustrating operation sequence at the time of the starting of the fixing apparatus or at a recovery time from the sleep state; and

FIG. 9 is diagram illustrating operation sequence at the time of the starting of a fixing apparatus or at a recovery time from a sleep state according to a modification.

### DETAILED DESCRIPTION

In accordance with an embodiment, a fixing belt has a non-magnetic metal layer and a magnetic metal layer. The thickness of the magnetic metal layer is larger than that the thickness of the non-magnetic metal layer.

Hereinafter, the fixing belt and a fixing apparatus according to an embodiment are described with reference to the accompanying drawings.

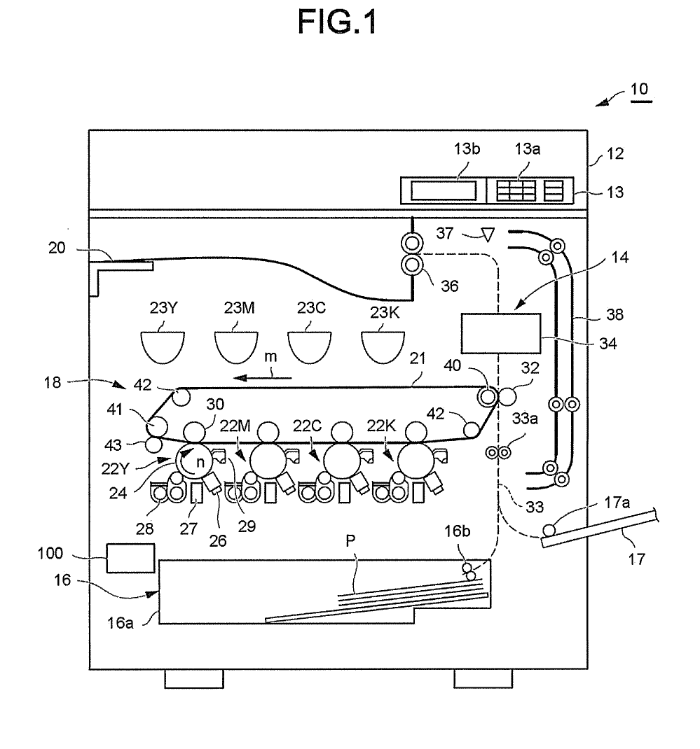

FIG. 1 is a side view illustrating an image forming apparatus 10 according to a first embodiment. Hereinafter, an MFP 10 is described as an example of the image forming apparatus 10.

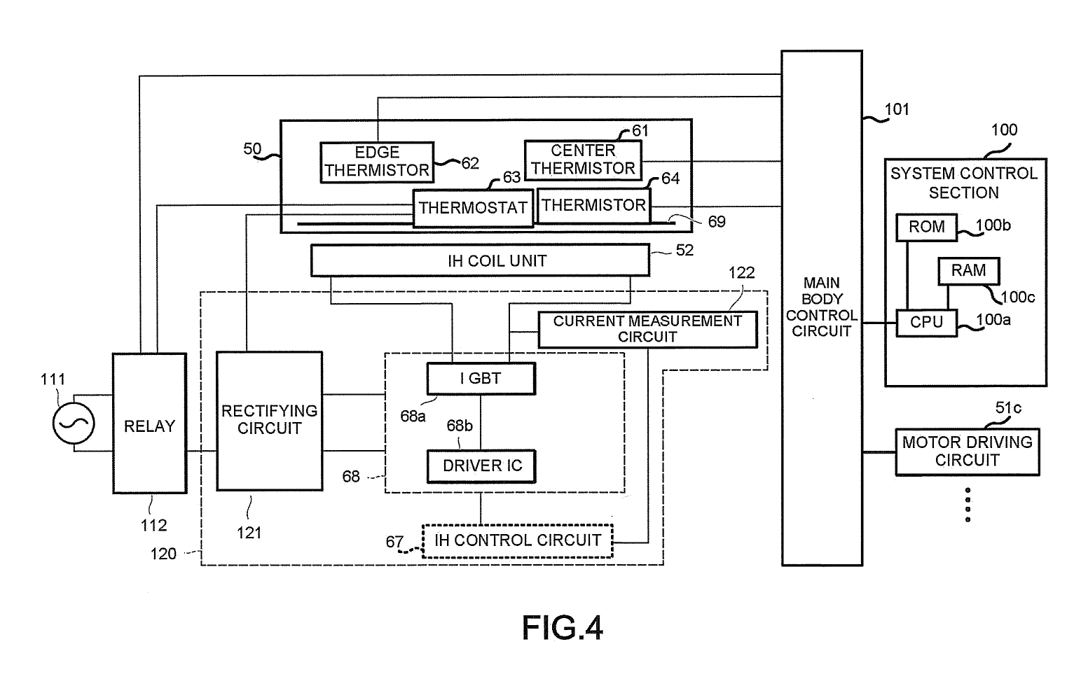

As shown in FIG. 1, the MFP 10 is equipped with a scanner 12, a control panel 13 and a main body section 14. Each of the scanner 12, the control panel 13 and the main body section 14 comprises a control section. The MFP 10 comprises a system control section 100 serving as a control section for collectively controlling each control section. The system control section 100 includes a CPU (Central Processing Unit) 100a, a ROM (Read Only Memory) 100b and a RAM (Random Access Memory) 100c (refer to FIG. 4).

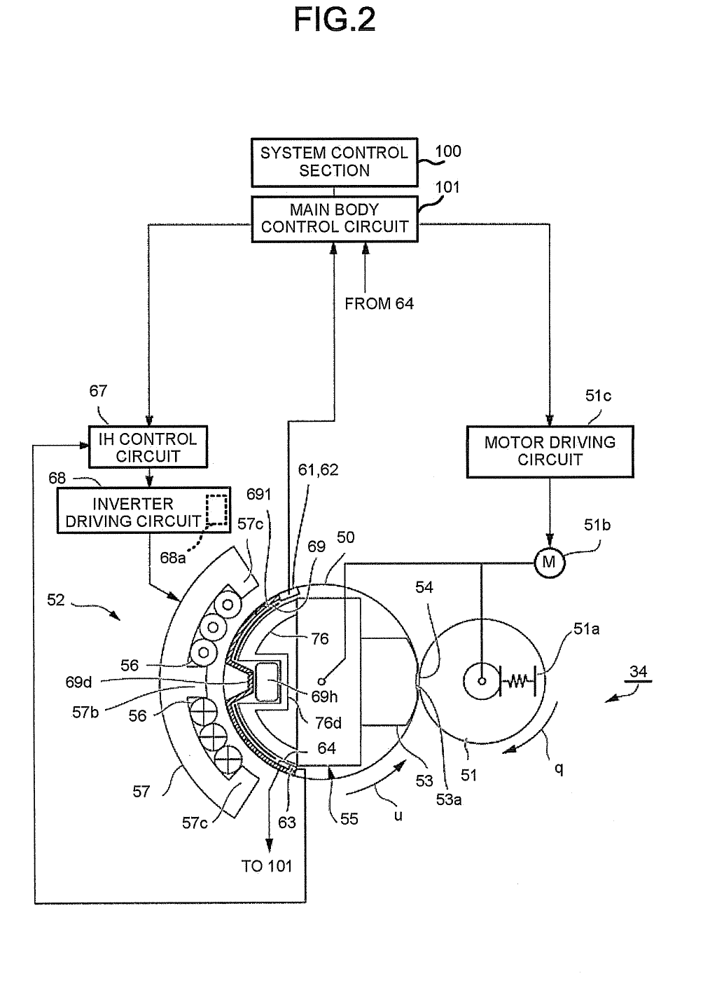

The system control section 100 controls a main body control circuit 101 (refer to FIG. 2) serving as a control section of the main body section 14. The main body control circuit 101 comprises a CPU, a ROM and a RAM (none is shown). The main body section 14 is equipped with a paper feed cassette section 16, a printer section 18 and a fixing apparatus 34. The main body control circuit 101 controls the paper feed cassette section 16, the printer section 18 and the fixing apparatus 34.

The scanner 12 reads an image of a document. The control panel 13 is equipped with input keys 13a and a display section 13b. For example, the input keys 13a receive an input from a user. For example, the display section 13b is a touch panel type. The display section 13b receives the input from the user to display information to the user.

The paper feed cassette section 16 comprises a paper feed cassette 16a and a pickup roller 16b. The paper feed cassette 16a stores sheets P serving as image receiving media. The pickup roller 16b picks up the sheet P from the paper feed cassette 16a.

The paper feed cassette 16a feeds the sheet P that is not used. A paper feed tray 17 feeds the unused sheet P with a pickup roller 17a.

The printer section 18 forms an image. For example, the printer section 18 carries out an image forming processing on the image of document read by the scanner 12. The printer section 18 is equipped with an intermediate transfer belt 21. The printer section 18 supports the intermediate transfer belt 21 through a backup roller 40, a driven roller 41 and a tension roller 42. The backup roller 40 is equipped with a driving section (not shown). The printer section 18 rotates the intermediate transfer belt 21 in a direction indicated by an arrow m.

The printer section 18 comprises four sets of image forming stations 22Y, 22M, 22C and 22K. The image forming stations 22Y, 22M, 22C and 22K are used to respectively form a Y (yellow) image, an M (magenta) image, a C (cyan) image and a K (black) image. The image forming stations 22Y, 22M, 22C and 22K are arranged in parallel to each other along a rotation direction of the intermediate transfer belt 21 below the intermediate transfer belt 21.

The printer section 18 is equipped with cartridges 23Y, 23M, 23C and 23K respectively above the image forming stations 22Y, 22M, 22C and 22K. The cartridges 23Y, 23M, 23C and 23K respectively store toner for replenishment of Y (yellow), M (magenta), C (cyan) and K (black) toner.

Hereinafter, the image forming station 22Y for forming the Y (yellow) image among the image forming stations 22Y, 22M, 22C and 22K is described as an example. Further, as the configurations of the image forming stations 22M, 22C and 22K are the same as the configuration of the image forming station 22Y, the detailed description thereof is omitted.

The image forming station 22Y comprises a charger 26, an exposure scanning head 27, a developing device 28 and a photoconductive cleaner 29. The charger 26, the exposure scanning head 27, the developing device 28 and the photoconductive cleaner 29 are arranged around a photoconductive drum 24 rotating in a direction indicated by an arrow n.

The image forming station 22Y includes a primary transfer roller 30. The primary transfer roller 30 faces the photoconductive drum 24 across the intermediate transfer belt 21.

The image forming station 22Y exposes the photoconductive drum 24 that is charged by the charger 26 through the exposure scanning head 27. The image forming station 22Y forms an electrostatic latent image on the photoconductive drum 24. The developing device 28 develops the electrostatic latent image on the photoconductive drum 24 using a two-component developing agent including toner and carrier.

The primary transfer roller 30 primarily transfers the toner image formed on the photoconductive drum 24 to the intermediate transfer belt 21. The image forming stations 22Y, 22M, 22C and 22K form a color toner image on the intermediate transfer belt 21 through the primary transfer roller 30. The color toner image is formed by overlapping toner images of Y (yellow), M (magenta), C (cyan) and K (black) in sequence. The photoconductive cleaner 29 removes the toner left on the photoconductive drum 24 after the primary transfer.

The printer section 18 includes a secondary transfer roller 32. The secondary transfer roller 32 faces a backup roller 40 across the intermediate transfer belt 21. The secondary transfer roller 32 secondarily transfers the color toner image on the intermediate transfer belt 21 collectively to the sheet P. The sheet P is fed by the paper feed cassette section 16 or a manual paper feeding tray 17 along a conveyance path 33.

The printer section 18 is equipped with a belt cleaner 43 facing a driven roller 41 across the intermediate transfer belt 21. The belt cleaner 43 removes the toner left on the intermediate transfer belt 21 after the secondary transfer.

The printer section 18 is equipped with a register roller 33a, a fixing apparatus 34 and a sheet discharge roller 36 along the conveyance path 33. The printer section 18 includes a bifurcating section 37 and a reversal conveyance section 38 at the downstream side of the fixing apparatus 34. The bifurcating section 37 sends the sheet P subjected to a fixing processing to a sheet discharge section 20 or the reversal conveyance section 38. In a case of a duplex printing, the reversal conveyance section 38 reverses the sheet P sent from the bifurcating section 37 to a direction of the register roller 33a and conveys it. The MFP 10 forms a fixed toner image on the sheet P with the printer section 18 and then discharges it to the sheet discharge section 20.

Further, the MFP 10 is not limited to the tandem developing system, and the number of the developing devices 28 is also not limited. Further, the MFP 10 may transfer the toner image from the photoconductive drum 24 to the sheet P directly.

Hereinafter, the fixing apparatus 34 is described in detail.

FIG. 2 is a side view containing an electromagnetic induction heating coil unit 52 and a control block of a main body control circuit 101. Hereinafter, the electromagnetic induction heating coil unit is referred to as an “IH coil unit”.

As shown in FIG. 2, the fixing apparatus 34 is equipped with a belt 50 (fixing belt), a press roller 51, an IH coil unit 52, a heat generation assistance plate 69 (magnetic material), an insulating member 691 (sheet), a shield 76 and the main body control circuit 101.

The fixing belt 50 is a cylindrical endless belt. On the inner peripheral surface of the fixing belt 50, a belt internal mechanism 55 including a nip pad 53 and the heat generation assistance plate 69 is arranged. In the present embodiment, the belt 50 contacts with the heat generation assistance plate 69.

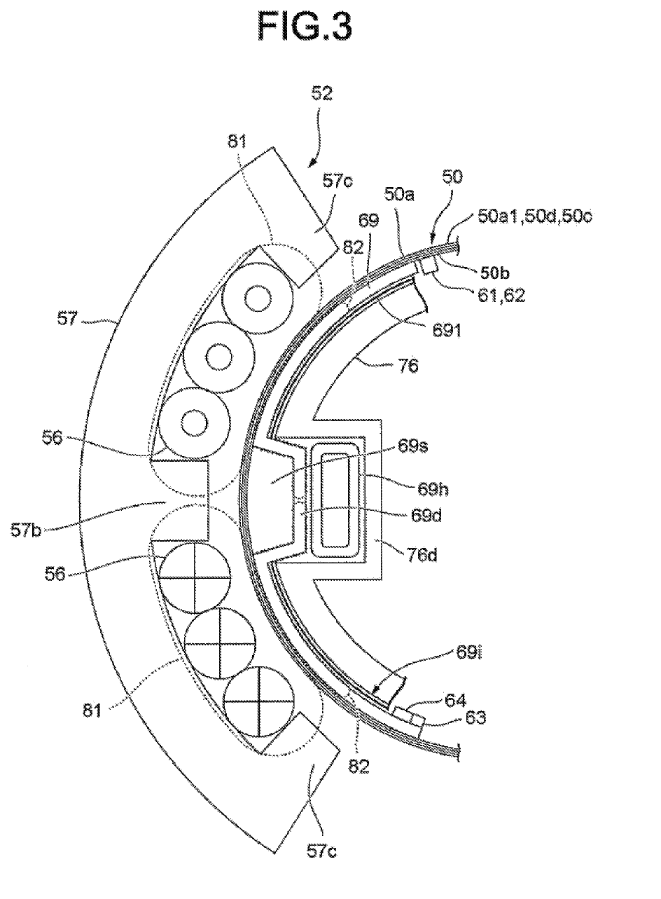

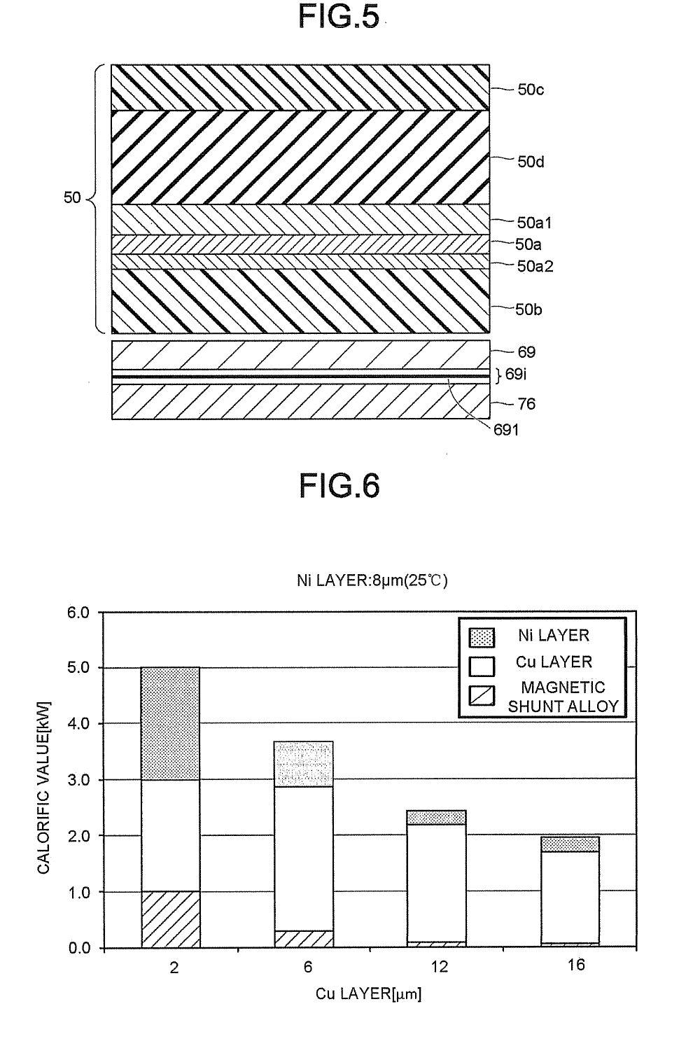

The fixing belt 50 is formed by laminating a heat generation layer 50a (conductive layer), a protective layer 50a1, an elastic layer 50d and a releasing layer 50c in sequence on a base layer 50b (refer to FIG. 3 and FIG. 5). Further, as long as the fixing belt 50 includes the heat generation layer 50a and the protective layer 50a1, no limitation is given to the layer constitution.

For example, the base layer 50b is made from polyimide resin (PI). For example, the heat generation layer 50a is formed by a non-magnetic metal such as copper (Cu) and becomes a main heat generation section in the belt 50. For example, the protective layer 50a1 is formed by the magnetic metal such as nickel (Ni). For example, the releasing layer 50c is made from fluorine resin such as PFA (Tetrafluoroethylene Perfluoro alkyl vinyl ether copolymer resin). For example, the elastic layer 50d is formed by an elastic body such as silicone rubber. The shape of the belt 50 is not limited.

In order to achieve a rapid warming up, the heat generation layer 50a becomes thin and thus the heat capacity of the fixing belt 50 becomes low. The warming-up is a processing containing a processing of increasing the temperature of the belt 50 to a temperature at which a fixing processing is executable. The fixing belt 50 having low heat capacity shortens the time required in warming-up and saves energy consumption.

For example, in order to reduce the heat capacity of the fixing belt 50, it is assumed that the thickness of the copper layer of the heat generation layer 50a is equal to or smaller than 12 μm. For example, the outer peripheral surface of the heat generation layer 50a is coated by the protective layer 50a1. The protective layer 50a1 can suppress the oxidation of the heat generation layer 50a. The protective layer 50a1 improves the mechanical strength of the fixing belt 50. The thickness of the protective layer 50a1 is described later.

Further, the heat generation layer 50a may be formed by performing copper plating after performing a surface treatment on the base layer 50b made from polyimide resin. By performing the surface treatment, the adhesion strength of the base layer 50b to the heat generation layer 50a is improved. For example, by performing electroless nickel plating as the surface treatment of the base layer 50b, the belt 50 improves the mechanical strength of the fixing belt 50.

Further, the surface of the base layer 50b may be roughened through sandblast or chemical etching. By roughening the surface of the base layer 50b, the belt 50 further mechanically improves the adhesion strength of the base layer 50b to the heat generation layer 50a.

Further, a metal such as titanium (Ti) maybe dispersed into the polyimide resin to form the base layer 50b. By dispersing the metal into the base layer 50b, the belt 50 further improves the adhesion strength of the base layer 50b to the heat generation layer 50a.

For example, the heat generation layer 50a may be made from non-magnetic metal such as aluminum (Al), copper (Cu) and silver (Ag) and the like. The heat generation layer 50a is not limited to non-magnetic pure metal and may be an alloy having non-magnetic properties. The heat generation layer 50a may be formed by combining two or more kinds of alloys or pure metals having the non-magnetic properties. Alternatively, the heat generation layer 50a may also be formed by overlapping two or more kinds of material selected from alloys or pure metals having the non-magnetic properties in a layered shape.

As shown in FIG. 2, the IH coil unit 52 is equipped with a main coil 56 and a core 57. For example, the main coil 56 is formed by winding litz wire bundling a plurality of copper wire coated with heat-resistant polyamide-imide which is an insulating material. A high frequency current is applied to the main coil 56 from an inverter driving circuit 68. Through enabling the high frequency current to flow to the main coil 56, high frequency magnetic field is generated in the vicinity of the main coil 56.

The core 57 becomes a magnetic path of the magnetic flux generated by the main coil 56. The core 57 has parts protruding to the belt 50 side. The protruding parts are arranged at a central part and ends of the core 57 along a circumferential direction of the belt 50. A core central protrusion 57b is arranged at the central part of the core 57. Core end protrusions 57c are arranged at both ends of the core 57.

By arranging the core central protrusion 57b and the core end protrusions 57c in the core 57, the magnetic flux generated by the main coil 56 can efficiently head for the belt 50 side.

With the magnetic flux in the high frequency magnetic field, an eddy current occurs in the heat generation layer 50a of the belt 50. Through the eddy current and electrical resistance of the heat generation layer 50a, Joule heat is generated in the heat generation layer 50a. Through the generation of the Joule heat, the belt 50 is heated.

The heat generation assistance plate 69 has a surface facing the belt 50. When viewed from a width direction (hereinafter, referred to as a “belt width direction”) of the belt 50, the heat generation assistance plate 69 is formed into an arc shape along the inner peripheral surface of the belt 50. The heat generation assistance plate 69 may be arc shape viewed from the belt width direction. The position of the heat generation assistance plate 69 is determined so that the arc-shape surface of the heat generation assistance plate 69 faces the belt 50. The heat generation assistance plate 69 faces the main coil 56 across the belt 50.

For example, the heat generation assistance plate 69 includes a magnetic material. The heat generation assistance plate 69 maybe formed by thin member having magnetic properties such as iron (Fe), nickel (Ni) and stainless (SUS). For example, the stainless having the magnetic properties may be a magnetic SUS material such as SUS 420. The heat generation assistance plate 69 may be a sintered body of the magnetic material such as ferrite or be formed by resin in which the magnetic powder is dispersed as long as the heat generation assistance plate 69 has the magnetic properties. The heat generation assistance plate 69 is not limited to the thin plate member. The heat generation assistance plate 69 may also be formed by combining two or more types of different magnetic material.

For example, the heat generation assistance plate 69 is a magnetic shunt alloy (ferromagnetism body) of which the Curie point is lower than that of the heat generation layer 50a. Through the magnetic flux generated by the main coil 56, magnetic flux is generated between the heat generation assistance plate 69 and the belt 50. Through the generation of the magnetic flux, the belt 50 is heated.

Two arc-shaped ends (upper end and lower end) of the heat generation assistance plate 69 are supported by a foundation (not shown). For example, the heat generation assistance plate 69 is pressed towards the belt 50. A lateral surface of the heat generation assistance plate 69 in a radial direction contacts the inner peripheral surface of the belt 50.

Through the belt internal mechanism 55, the heat generation assistance plate 69 may be close to/away from the belt 50. For example, the belt internal mechanism 55 may enable the lateral surface of the heat generation assistance plate 69 in the radial direction to separate from the inner peripheral surface of the belt 50 at the time of warming up the fixing apparatus 34.

FIG. 3 is a view illustrating the magnetic paths to the belt 50 and the heat generation assistance plate 69 by the magnetic flux of the main coil 56.

As shown in FIG. 3, the magnetic flux generated by the main coil 56 forms a first magnetic path 81 induced to the heat generation layer 50a of the belt 50. The first magnetic path 81 passes through a core 57 of the main coil 56 and the heat generation layer 50a of the belt 50. The magnetic flux generated by the main coil 56 forms a second magnetic path 82 induced to the heat generation assistance plate 69. The second magnetic path 82 is formed at a position adjacent to the first magnetic path 81 in a radial direction of the belt 50. The second magnetic path 82 passes through the heat generation assistance plate 69 and the heat generation layer 50a.

For example, the surface of the heat generation assistance plate 69 at the belt 50 side is arranged to contact with the inner surface of the belt 50. The heat generation assistance plate 69 has a recess 69d recessed towards a shaft side of the belt 50. The recess 69d enables a part of the surface of the heat generation assistance plate 69 facing the belt 50 to separate from the inner surface of the belt 50. The recess 69d is arranged at a position facing the core central protrusion 57b in the IH coil unit 52. For example, in the circumferential direction of the belt 50, the width of the recess 69d has length corresponding to the width of the core central protrusion 57b. The recess 69d and the core central protrusion 57b are arranged to face each other. In this way, the distance from the core central protrusion 57b to the heat generation assistance plate 69 is longer than that in a case in which there is no recess 69d. As a result, the magnetic flux in the vicinity of the core central protrusion 57b is difficult to decay compared with the case where there is no recess 69d. By arranging the recess 69d in the heat generation assistance plate 69, the IH coil unit 52 can efficiently form the first magnetic path 81 due to the generated magnetic flux.

Incidentally, the recess area may be configured as space without providing filler in a recess of the recess 69d. Alternatively, an elastic body 69s for holding lubricating oil such as silicone oil may be arranged in the recess 69d. For example, the elastic body 69s is arranged to contact with the inner peripheral surface of the belt 50. Through the rotation of the belt 50, the inner peripheral surface of the belt 50 is coated by the lubricating oil. Through the lubricating oil, frictional resistance of sliding contact between the belt 50 and the heat generation assistance plate 69 is reduced. Through the lubricating oil existing between the belt 50 and the heat generation assistance plate 69, it is possible to reduce the thermal resistance between the belt 50 and the heat generation assistance plate 69.

The heat generation assistance plate 69 may be magnetic material of which the Curie point is lower than that of the heat generation layer 50a of the belt 50 as stated above. For example, the heat generation assistance plate 69 is formed by a thin metal member made from the magnetic shunt alloy such as iron or nickel alloy the Curie point of which is 220 degrees centigrade-230 degrees centigrade. The magnetism of the heat generation assistance plate 69 changes from the ferromagnetism to the paramagnetism if the temperature exceeds the Curie point thereof. If the temperature of the heat generation assistance plate 69 exceeds the Curie point, the second magnetic path 82 is not formed, thereby not assisting the heating of the belt 50. Through forming the heat generation assistance plate 69 with the magnetic shunt alloy, by taking the Curie point as a boundary, the heat generation assistance plate 69 can assist rise of the temperature of the belt 50 at the time of a low temperature and suppress excessive rise of the temperature of the belt 50 at the time of a high temperature.

As shown in FIG. 2, a shield 76 is arranged at the inner peripheral side of the heat generation assistance plate 69 along the inner peripheral surface thereof. For example, the shield 76 has a substantially arc-shape surface viewed from the belt width direction similar to the heat generation assistance plate 69. The shield 76 may be a substantially arc shape viewed from the belt width direction. Two arc-shaped ends of the shield 76 are supported by a foundation (not shown). The shield 76 may support the heat generation assistance plate 69. For example, the shield 76 is formed by a non-magnetic material such as aluminum and copper. The shield 76 shields the magnetic flux from the IH coil unit 52. The shield 76 has a recess 76d recessed towards a shaft side of the belt 50. The recess 76d enables a part of the shield 76 to separate from the inner surface of the belt 50. The recess 76d is arranged at a position facing the core central protrusion 57b in the IH coil unit 52 similar to the recess 69d. For example, in the circumferential direction of the belt 50, the width of the recess 76d corresponds to the width of the recess 69d. The recess 76d and the core central protrusion 57b are arranged to face each other. In this way, the distance from the core central protrusion 57b to the shield 76 is longer than that in a case in which there is no recess 76d. By arranging the recess 76d in the shield 76, the IH coil unit 52 can efficiently form the first magnetic path 81 due to the generated magnetic flux.

The shield 76 is arranged apart from the heat generation assistance plate 69 by sandwiching a heat insulating layer 69i therebetween.

An insulating member 691 is arranged in the heat insulating layer 69i except for a range corresponding to the recess 69d of the heat generation assistance plate 69. The insulating member 691 is described in detail later.

A heat pipe 69h is arranged corresponding to the recess 69d. The heat pipe 69h is arranged at the opposite side of the belt 50 with respect to the heat generation assistance plate 69, in other words, in a recess of the recess 76d at the back side of the heat generation assistance plate 69 viewed from the belt 50 side. The heat pipe 69h increases heat dissipation from the heat generation assistance plate 69 and increases the speed of decrease in temperature.

Returning to FIG. 2, a nip pad 53 is described. At the inner peripheral side of the belt 50, the nip pad 53 presses the inner peripheral surface of the belt 50 to the press roller 51 side. A nip 54 is formed between the belt 50 and the press roller 51. The nip pad 53 has a nip forming surface 53a between the belt 50 and the press roller 51. When viewed from the belt width direction, the nip forming surface 53a curves to form a convex towards the inner peripheral surface of the belt 50. When viewed from the belt width direction, the nip forming surface 53a curves along the outer peripheral surface of the press roller 51.

For example, the nip pad 53 is formed by elastic material such as silicon rubber and fluorine rubber. The nip pad 53 may be formed by heat-resistant resin. For example, the heat-resistant resin is PI (polyimide resin), PPS (polyphenylene sulfide resin), PES (polyether sulphone resin), LCP (liquid crystal polymer) and PF (phenol resin) and the like.

For example, a sheet-like friction reducing member is arranged between the belt 50 and the nip pad 53. For example, the friction reducing member is formed by a sheet member and the releasing layer having excellent sliding properties and good wear resistance. The friction reducing member is fixedly supported by the belt internal mechanism 55. The friction reducing member slidably contacts the inner peripheral surface of the belt 50 that is operating. The friction reducing member maybe formed by the following sheet member with lubricity. For example, the sheet member may be composed of glass fiber sheet impregnated with fluororesin.

For example, the press roller 51 is equipped with a silicone sponge and a silicone rubber layer having heat-resistance around a core metal thereof. For example, a releasing layer is arranged on the surface of the press roller 51. The releasing layer is formed by the fluorine-based resin such as PFA resin. The press roller 51 pressurizes the belt 50 by a pressure mechanism 51a.

As a driving source of the belt 50 and the press roller 51, one motor 51b (driving section) is arranged. The motor 51b is driven by a motor driving circuit 51c controlled by the main body control circuit 101. The motor 51b is connected with the press roller 51 via a first gear row (not shown). The motor 51b is connected with a belt driving member via a second gear row and a one-way clutch (none is shown). The press roller 51 rotates in an arrow q direction through the motor 51b. In a case in which the belt 50 abuts against the press roller 51, the belt 50 is driven by the press roller 51 to rotate in an arrow u direction. In a case in which the belt 50 is separated from the press roller 51, the belt 50 rotates in an arrow u direction through the motor 51b. Further, the belt 50 may be separated from the press roller 51 and have a driving source thereof. For example, teeth engaged with the gear are arranged at the ends of the belt 50 along a moving direction thereof, and the belt 50 is driven in response to rotation of the gear to be driven to rotate by a motor (not shown).

At the inner peripheral side of the belt 50, a center thermistor 61 and an edge thermistor 62 (temperature measurement sections) are arranged. The center thermistor 61 and the edge thermistor 62 are used to measure the temperature of the belt 50. The measurement result of the temperature of the belt 50 is input to the main body control circuit 101. The center thermistor 61 is arranged at the inner side of the belt width direction. The edge thermistor 62 is arranged in the heating area of the IH coil unit 52 and the sheet non-passing area in the belt width direction. The main body control circuit 101 stops the output of the electromagnetic induction heating in a case in which the temperature of the belt 50 measured by the edge thermistor 62 is equal to or greater than a threshold value. By stopping the output of the electromagnetic induction heating when the temperature of the sheet non-passing area of the belt 50 excessively rises, the main body control circuit 101 prevents the damage of the belt 50.

Further, in addition to the center thermistor 61 and the edge thermistor 62, a thermistor 64 may be arranged in the heat generation assistance plate 69. The thermistor 64 measures the temperature of the heat generation assistance plate 69. The measurement result of the temperature of the heat generation assistance plate 69 is input to the main body control circuit 101. For example, the main body control circuit 101 may enable the heat generation assistance plate 69 abut against the belt 50 if the temperature of the heat generation assistance plate 69 measured by the thermistor 64 is equal to or greater than the threshold value.

The main body control circuit 101 controls an IH control circuit 67 according to the measurement result of the temperature of the belt 50 by the center thermistor 61 and the edge thermistor 62. The IH control circuit 67 controls the value of the high frequency current output by the inverter driving circuit 68 under the control of the main body control circuit 101. The temperature of the belt 50 is maintained in various control temperature ranges according to the output by the inverter driving circuit 68. The IH control circuit 67 is equipped with a CPU, a ROM and a RAM (none is shown).

For example, a thermostat 63 is arranged in the belt internal mechanism 55. The thermostat 63 functions as a safety device of the fixing apparatus 34. The thermostat 63 operates when the belt 50 generates abnormal heat and the temperature thereof rises to a cut-off threshold value. Through the operation of the thermostat 63, the current to the IH coil unit 52 is cut off. Through cutting off the current to the IH coil unit 52, the abnormal heat generation of the fixing apparatus 34 can be prevented.

FIG. 4 is a block diagram illustrating the control of the IH coil unit 52 according to the first embodiment as a main body.

As shown in FIG. 4, the MFP 10 (refer to FIG. 1) is equipped with the system control section 100, the main body control circuit 101, an IH circuit 120 and the motor driving circuit 51c. The IH circuit 120 is equipped with a rectifying circuit 121, the IH control circuit 67, the inverter driving circuit 68 and a current measurement circuit 122.

The current is input to the IH circuit 120 via a relay 112 from an alternating-current power supply 111. The IH circuit 120 rectifies the input current through the rectifying circuit 121 to supply the rectified current to the inverter driving circuit 68. In a case in which the thermostat 63 is cut off, the relay 112 cuts off the current from the alternating-current power supply 111. The inverter driving circuit 68 is equipped with a driver IC 68b of an IGBT (Insulated Gate Bipolar Transistor) element 68a. The IH control circuit 67 controls the driver IC 68b according to the measurement result of the temperature of the belt 50 by the center thermistor 61 and the edge thermistor 62. The IH control circuit 67 controls the driver IC 68b to control the output of the ICBT element 68a. The current measurement circuit 122 sends the measurement result of the output of the IGBT element 68a to the IH control circuit 67. The IH control circuit 67 controls the driver IC 68b to make the output of the IH coil unit 52 constant based on the measurement result of the output of the ICBT element 68a by the current measurement circuit 122.

The main body control circuit 101 acquires the temperature of the belt 50 from the center thermistor 61 and the edge thermistor 62. In a case in which the belt 50 contacts the heat generation assistance plate 69, the belt temperature is substantially the same as the temperature of the heat generation assistance plate 69. Thus, through acquiring the belt temperature, the temperature of the heat generation assistance plate 69 may also be indirectly acquired. In the standby state, the main body control circuit 101 controls the frequency applied to the IH coil unit 52 based on the belt temperature to enable the IH output to approach to the target value. In a case in which the belt 50 does not contact the heat generation assistance plate 69, the belt temperature is different from the temperature of the heat generation assistance plate 69 in some cases. In this case, the main body control circuit 101 may acquire the temperature detected by the thermistor 64 as the temperature of the heat generation assistance plate 69.

Further, “the standby state” refers to a standby state in which the fixing apparatus 34 does not execute the fixing operation and is equivalent to a state in which the MFP 10 (refer to FIG. 1) does not receive the print request.

(About Shortening of Time Required Until Starting of Forming Image)

First, the shortening of the time required from the dormant state to the starting of forming an image of the fixing apparatus 34 is described. The time required from the dormant state to the starting of forming an image refers to time required for the starting of the fixing apparatus 34 or recovery time from the dormant state (sleep state). Hereinafter, the time required from the dormant state to the starting of forming an image is referred to as the recovery time.

The fixing apparatus 34 shortens the recovery time without increasing amount of the energy consumption. For example, the heat capacity of the belt 50 is reduced to increase temperature rising speed of the belt 50. If the heat capacity is reduced, the belt 50 cannot accumulate needed heat quantity.

For example, if the copper layer serving as the heat generation layer 50a is relatively thin, the heat capacity of the belt 50 is reduced, and the heating efficiency of the belt 50 is improved. On the other hand, the belt 50 is impossible to accumulate the heat quantity required for fixing operation due to reducing the heat capacity in some cases. In this case, fixing failure (low-temperature offset) may occur. The increasing of the temperature rising rate of the belt 50 and the accumulation of the heat quantity required for fixing operation by the belt become a trade-off.

For example, the fixing apparatus of a comparative embodiment that is capable of lowering the rotational speed of the belt 50 can lower the rotational speed of the belt 50 to avoid the occurrence of the above trade-off. The fixing apparatus of the comparative embodiment is difficult to shorten the recovery time.

In contrast, in a case in which the recovery time is required to be shortened, the same measure as described above cannot be taken. In the present embodiment, while ensuring the heat capacity necessary for the belt 50, the above-mentioned trade-off is overcome to improve the heating efficiency.

(Relation among Configuration of Belt 50, Heat Generation Assistance Plate 69 and Shield 76)

First, with reference to FIG. 5, the configuration of the belt 50 of the present embodiment is described. FIG. 5 is a diagram illustrating the configuration of the belt 50. The belt 50 is formed by sequentially stacking the heat generation layer 50a, the protective layer 50a1, the elastic layer 50d and the releasing layer 50c on the base layer 50b. An adhesive layer 50a2 made of nickel may be arranged between the base layer 50b and the heat generation layer 50a. In the present embodiment, the protective layer 50a1 functions to assist heat generation in addition to the calorific value of the heat generation layer 50a. Incidentally, in addition to the above function, the protective layer 50a1 has a protection function to protect the belt 50 by preventing oxidation of the surface of the heat generation layer 50a and a durability improvement function to improve the durability of the belt 50.

For comparison, a belt of the comparative embodiment is described. The protective layer of the belt of the comparative embodiment has a protection function to protect the belt by preventing oxidation of the surface of the heat generation layer 50a and a durability improvement function to improve the durability of the belt 50. The thickness of the protective layer of the belt of the comparative embodiment is determined so as to make the protection function and the durability improvement function effective.

In contrast, in the belt 50 of the present embodiment, the thickness of the protective layer 50a1 is determined so as to satisfy the following conditions. The thickness of the protective layer 50a1 is determined so as to make a heat generation holding function for assisting heat generation by the heat generation layer 50a, the protection function and the durability improvement function effective.

Next, the relation among the belt 50, the heat generation assistance plate 69 and the shield 76 is described.

The belt 50 and the heat generation assistance plate 69 are arranged to contact with each other or be away from each other by a distance at which they can heat each other.

The heat generation assistance plate 69 and the shield 76 are arranged by sandwiching the heat insulating layer 69i. The heat insulating layer 69i is constituted so as to make the thermal resistance between the heat generation assistance plate 69 and the shield 76 relatively high. For example, the heat insulating layer 69i may be an air layer formed by arranging the heat generation assistance plate 69 and the shield 76 at a predetermined distance. Alternatively, the heat insulating layer 69i is constituted so as to make the electrical resistance between the heat generation assistance plate 69 and the shield 76 relatively high. For example, the heat insulating layer 69i insulates the space between the heat generation assistance plate 69 and the shield 76. For example, air or other insulating members 691 may be filled between the heat generation assistance plate 69 and the shield 76. The insulating member 691 may, for example, sheet material containing polyimide (Kapton® Technology, etc.) or aramid (Nomex® Technology, etc.) as the material. The insulating member 691 may be formed as a film or a sheet in which fiber is woven. It is desired the thickness of the insulating member 691 in that case is from 0.1 mm to 0.5 mm.

Between the heat generation assistance plate 69 and the shield 76, the heat insulating layer 69i which is formed by including the insulating member 691 is arranged. In this way, the apparent heat capacity of the belt 50 becomes small, and the heating efficiency of the belt 50 is improved. For example, the MFP 10 that is placed in the dormant state at night and the like lowers the temperature of the belt 50 and the heat generation assistance plate 69 to a relatively low temperature. The heat insulating layer 69i is arranged and the heating efficiency described above is improved, and thus, initial heating shortage of the heat generation assistance plate 69 after the dormant state of the MFP 10 is released is compensated, which contributes to the shortening of the rise time from the dormant state the like.

At the time of continuously passing the paper, the heat generation assistance plate 69, the heat insulating layer 69i and the shield 76 are warmed to a relatively high temperature. The belt 50 receives the heat and the viscosity of lubricant (silicon oil) coating the inner surface of the belt 50 decreases. Through decreasing of the viscosity of the lubricant, the thermal resistance between the belt 50 and the heat generation assistance plate 69 is lowered, and thermal conductivity between the belt 50 and the heat generation assistance plate 69 is increased. In addition, if the thickness of the insulating member 691 is from 0.1 mm to 0.5 mm, the heat of the heat generation assistance plate 69 and the shield 76 can be used to stabilize the temperature of the belt 50. In the above case, the apparent heat capacity of the belt 50 is increased, and the heat of the belt 50, the heat generation assistance plate 69 and the shield 76 can be effectively used, thereby achieving the effect of reducing the power consumption. Further, the printing speed can be accelerated in the foregoing state.

If the thickness of the heat insulating layer 69i or the insulating member 691 is equal to or greater than 0.5 mm, the thermal resistance among the heat generation assistance plate 69, the heat insulating layer 69i and the shield 76 is increased, and the heat conduction is extremely bad. As a result, although the apparent heat capacity of the belt 50 is reduced and the rise time from the dormant state is shortened, the thickness of the heat insulating layer 69i or the insulating member 691 is not suitable for accelerating the print speed.

(About Thickness of Protective Layer and Thickness of Heat Generation Layer)

FIG. 6 is a diagram illustrating a relation of the calorific value with respect to the thickness of the protective layer and the thickness of the heat generation layer. In FIG. 6, a case in which the nickel is applied to the material of the protective layer 50a1 and the copper is applied to the material of the heat generation layer 50a is exemplified. Further, in FIG. 6, a case in which the magnetic shunt alloy is applied to the material of the heat generation assistance plate 69 and the aluminum is applied to the material of the shield 76 is shown. FIG. 6 shows results generated by analyzing the calorific value of the whole belt 50 through electromagnetic field analysis in a case of fixing the thickness of the nickel layer of the belt 50 to 8 μm and changing the thickness of the copper layer. The analysis results shown in FIG. 6 are generated in a case of respectively setting the thickness of the copper layer to 2 μm, 6 μm, 12 μm and 16 μm.

The calorific value of the nickel layer increases as the thickness of the copper layer becomes thinner. The calorific value of the nickel layer and the copper layer and the calorific value of the whole belt 50 increase as the thickness of the copper layer becomes thinner.

However, if the thickness of the copper layer is too thin and exceeds a certain range, shielding effect of the magnetic flux by the copper layer is reduced and the magnetic flux reaching the heat generation assistance plate 69 (magnetic shunt alloy) is increased. In this way, the heat generation assistance plate 69 (magnetic shunt alloy) arranged at the inside of the belt 50 is easily heated. In this case, the temperature of the magnetic shunt alloy is raised, the magnetic properties of the magnetic shunt alloy are lost, and the calorific value by the magnetic flux is reduced. For example, if the thickness of the copper layer is equal to or lower than 8 μm, the heating efficiency of the belt 50 is poor and the temperature rise speed thereof is slow. In the foregoing case, it is desired that the thickness of the copper layer is at least 5 μm or more so that the temperature of the generation assistance plate 69 (magnetic shunt alloy) is prevented from exceeding the Curie temperature.

If the thickness of the nickel layer becomes thin, the durability of the belt 50 decreases. In order to maintain the durability of the belt 50, the thickness of the nickel layer is required to be 6 μm or more. In contrast, the thicker the thickness of the nickel layer becomes, the larger the heat capacity by the protective layer 50a1 becomes, and the slower the temperature rise of the belt 50 becomes. Consequently, the thickness of the nickel layer is required to be thinner than a predetermined thickness. For example, the predetermined thickness is set to 12 μm, and the thickness of the nickel layer is equal to or smaller 12 μm serving as predetermined thickness.

According to the results of the above study, in the belt 50 of the present embodiment, the thickness of the copper layer is determined as 6 μm, and the thickness of the nickel layer is determined as 10 μm, and then the effect of the belt 50 is evaluated. By mounting the belt 50 to the MFP 10, it is confirmed that satisfactorily print reaching a print speed of 85 sheets in 1 minute can be realized. The belt of the comparative embodiment is obtained by setting the thickness of the copper layer to 10 μm and the thickness of the nickel layer to 8 μm. The MFP 10 is possible to increase the print speed by using the above the belt 50 compared with a case of using the belt of the comparative embodiment. Thus, the belt 50 can increase the independent temperature rise properties.

(About Shortening of Time Required For Starting of Fixing Apparatus 34)

Further, through enabling the fixing apparatus 34 to execute the following operations, the time required for the starting of the fixing apparatus 34 is shortened to be substantially equal to the temperature rising time of the belt 50 in a case of heating the belt 50 independently.

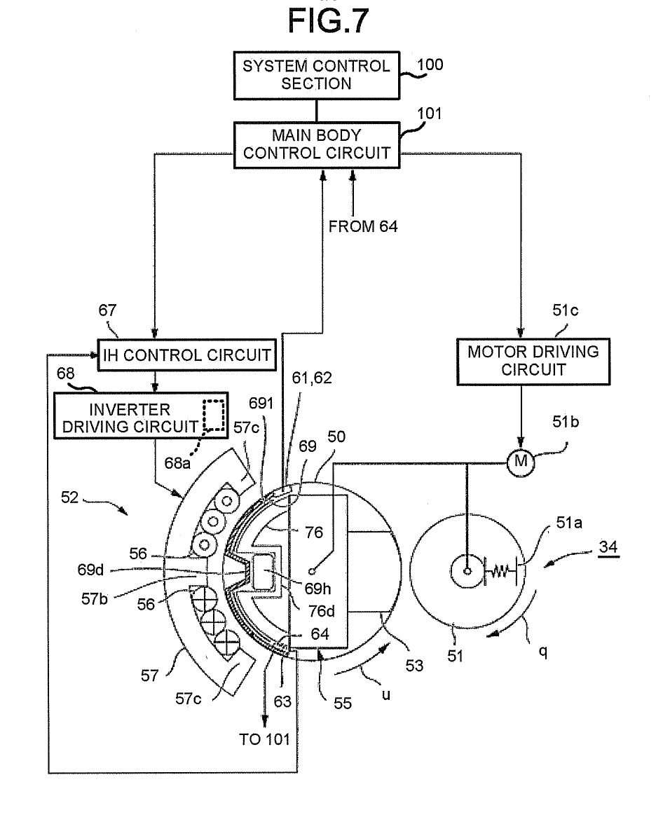

FIG. 7 is a diagram illustrating the time of the starting of a fixing apparatus or a sleep state.

At the time the fixing apparatus 34 is in a non-energized state (power off) or in a dormant state (sleep state), the press roller 51 is maintained in a state separated from the belt 50. Further, the heat generation assistance plate 69 is maintained in a state separated from the belt 50. Through the above, at the time the fixing apparatus 34 is in the non-energized state (power off) or in the dormant state. If the belt 50 serving an object to be heated is in a non-contact state with the generation assistance plate 69, the heat quantity generated by the belt 50 itself is used to heat only the heat capacity of the belt 50. In other words, the heat quantity generated by the heating of the belt 50 is not conducted to other objects and the belt 50 is rapidly heated.

Further, the heat generation assistance plate 69 is maintained in a state separated from the belt 50. In the heat generation assistance plate 69, the eddy current is generated by the magnetic flux penetrating the belt 50. The temperature of the heat generation assistance plate 69 is gradually increased through the self-heating by the eddy current.

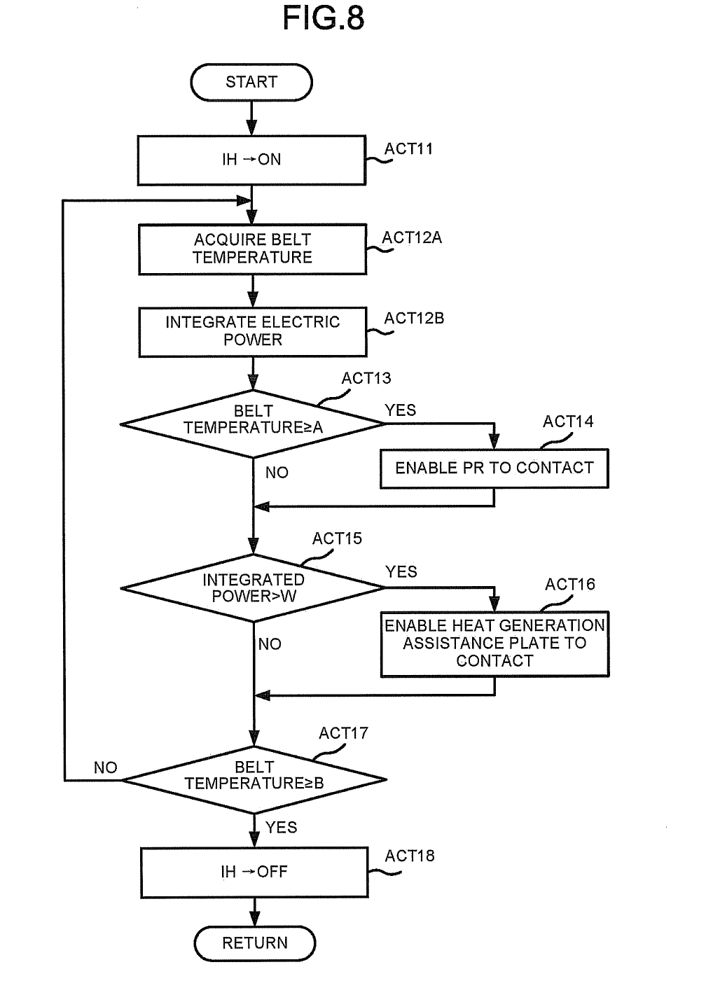

With reference to FIG. 8, operations at the time of the starting of the fixing apparatus or at the recovery time from the sleep state are described. FIG. 8 is diagram illustrating operation sequence at the time of the starting of the fixing apparatus or at a recovery time from the sleep state.

The system control section 100 detects an operation (referred to as a start-up operation) for instructing the starting (power on) or the recovery from the sleep state. The main body control circuit 101 starts (IH->ON) heating by the IH coil unit 52 (ACT 11).

Next, the main body control circuit 101 acquires the temperature detected by the center thermistor 61 and the edge thermistor 62 after starting the heating operation (ACT 12A). The main body control circuit 101 integrates the electric power required to enable the IH coil unit 52 to operate and heat the belt 50. The main body control circuit 101 acquires the integrated value as integrated power (ACT 12B).

Next, the main body control circuit 101 determines whether or not the temperature of the belt 50 reaches a predetermined temperature (A) after starting the heating operation (ACT 13). For example, the predetermined temperature (A) is a lower limit temperature of a temperature range to which the temperature of the belt 50 is independently increased until the press roller (PR) 51 is enabled to contact with the belt 50.

Next, if it is determined that the temperature of the belt 50 reaches the predetermined temperature (A) (Yes in ACT 13), the main body control circuit 101 enables the press roller (PR) 51 to contact with the belt 50 (ACT 14).

If the temperature of the belt 50 does not reach the predetermined temperature (A) (No in ACT 13), alternatively, after the processing in ACT 14 is terminated, the main body control circuit 101 proceeds to the processing in ACT 15. The main body control circuit 101 determines whether or not the integrated value (integrated power) of the electric power consumed by heating the belt 50 exceeds a predetermined value (W) (ACT 15). If it is determined that the integrated power exceeds the predetermined value (W) (Yes in ACT 15), the main body control circuit 101 enables the heat generation assistance plate 69 to contact with the belt 50 (ACT 16).

If the integrated power does not exceed the predetermined value (W) (No in ACT 15), alternatively, after the processing in ACT 16 is terminated, the main body control circuit 101 proceeds the processing in ACT 17. The main body control circuit 101 determines whether or not the temperature of the belt 50 reaches a Ready temperature (B) (ACT 17). The Ready temperature (B) refers to a representative temperature of a temperature range at which the heating of the temperature of the belt 50 may be interrupted. For example, the Ready temperature (B) is set to a temperature higher than the predetermined temperature (A). If it is determined that the temperature of the belt 50 does not reach the Ready temperature (B) (No in ACT 17), the main body control circuit 101 repeats the processing subsequent to ACT 12A in the same way as stated above. If it is determined that the temperature of the belt 50 reaches the Ready temperature (B) (Yes in ACT 17), the main body control circuit 101 stops (IH->ON) the heating by the IH coil unit 52 (ACT 18). After terminating a series of the processing relating to the start-up operation, the main body control circuit 101 enables the fixing apparatus 34 to be a standby state. Further, in the processing in ACT 18 described above, the main body control circuit 101 stops the heating by the IH coil unit 52; however, the following operation may be executed instead of that . For example, the main body control circuit 101 may reduce the current flowing to the IH coil unit 52 to reduce the calorific value of the belt 50.

According to the foregoing processing, the main body control circuit 101 presumes the temperature of each section before the heat generation assistance plate 69 is enabled to contact with the belt 50 by taking the integrated value of the electric power required for the heating of the belt 50 as a reference. The main body control circuit 101 enables the heat generation assistance plate 69 to contact with the belt 50 after determining that the temperature of each section is in a desired temperature range. In this way, the main body control circuit 101 can manage the time required to increase the temperature of the belt 50. The main body control circuit 101 enables the heat generation assistance plate 69 to contact with the belt 50 after presuming that the temperature of each section is in a desired temperature range. In this way, the main body control circuit 101 can shorten the time required until the fixing apparatus 34 is recovered to a state in which an image can be formed by taking the integrated value of the electric power required for the heating of the belt 50 as a reference.

### Modification of Embodiment

A modification of the embodiment is described. The main body control circuit 101 according to the embodiment presumes the temperature of each section before the heat generation assistance plate 69 is enabled to contact with the belt 50 by taking the integrated value of the electric power required for the heating of the belt 50 as a reference. Instead, the main body control circuit 101 according to the modification presumes the temperature of each section before the heat generation assistance plate 69 is enabled to contact with the belt 50 by taking the temperature of the heat generation assistance plate 69 as a reference.

As shown in FIG. 2 to FIG. 4, the heat generation assistance plate 69 is equipped with the thermistor 64 for detecting the temperature of the heat generation assistance plate 69. The main body control circuit 101 collects information of the temperature of the heat generation assistance plate 69 detected by the thermistor 64.

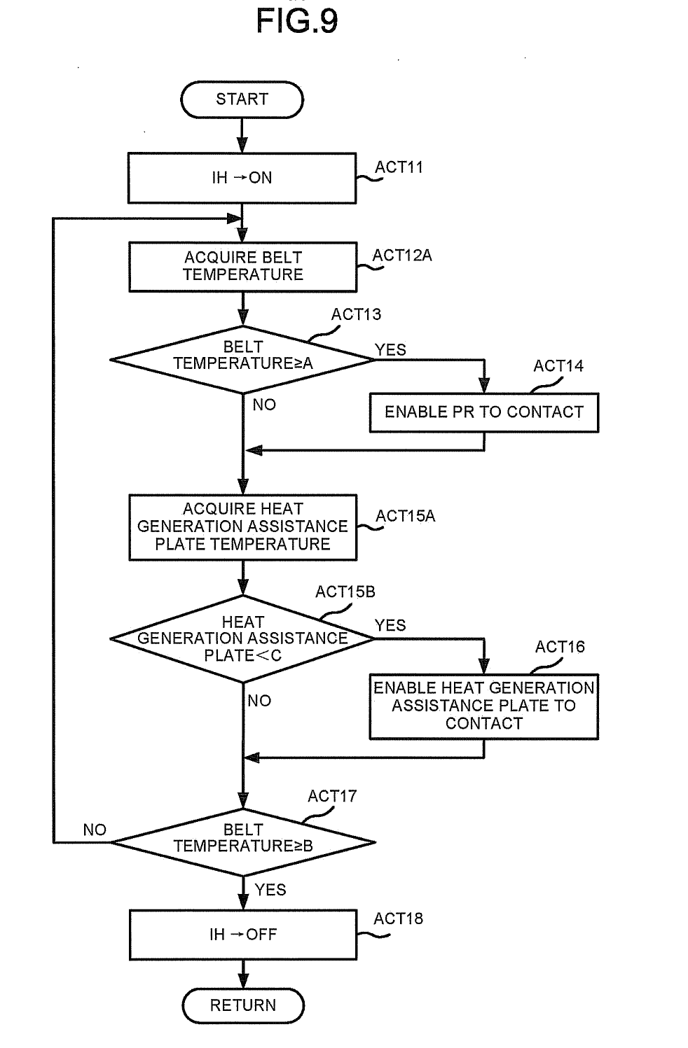

FIG. 9 is diagram illustrating operation sequence at the time of the starting of a fixing apparatus or at a recovery time from a sleep state. The description thereof is executed by centering on points different from FIG. 8.

The system control section 100 detects an operation (referred to as a start-up operation) for instructing the starting (power on) or the recovery from the sleep state. The main body control circuit 101 starts (IH->ON) heating by the IH coil unit 52 (ACT 11).

Next, the main body control circuit 101 acquires the temperature detected by the center thermistor 61 and the edge thermistor 62 after starting the heating operation (ACT 12A). The main body control circuit 101 determines whether or not the temperature of the belt 50 reaches the predetermined temperature (A) (ACT 13). If it is determined that the temperature of the belt 50 reaches the predetermined temperature (A) (Yes in ACT 13), the main body control circuit 101 enables the press roller (PR) 51 to contact with the belt 50 (ACT 14).

If it is determined that the temperature of the belt 50 does not reach the predetermined temperature (A) (No in ACT 13), alternatively, after the processing in ACT 14 is terminated, the main body control circuit 101 proceeds to the processing in ACT 15A. The main body control circuit 101 acquires the temperature of the heat generation assistance plate 69 detected by the thermistor 64 (ACT 15A). The main body control circuit 101 determines whether or not the temperature of the heat generation assistance plate 69 exceeds a predetermined temperature (C) (ACT 15B). If it is determined that the temperature of the heat generation assistance plate 69 exceeds the predetermined temperature (C) (Yes in ACT 15B), the main body control circuit 101 enables the heat generation assistance plate 69 to contact with the belt 50 (ACT 16).

If it is determined that the temperature of the heat generation assistance plate 69 does not exceed the predetermined temperature (C) (No in ACT 15B), alternatively, the processing in ACT 16 is terminated, the main body control circuit 101 proceeds to the processing in ACT 17. The procedures after the processing in ACT 17 are the same as FIG. 8.

According to the foregoing processing, the main body control circuit 101 determines whether the temperature of each section is in a desired temperature range before the heat generation assistance plate 69 is enabled to contact with the belt 50 by taking the temperature of the heat generation assistance plate 69 as a reference. The main body control circuit 101 enables the heat generation assistance plate 69 to contact with the belt 50 after determining that the temperature of each section is in a desired temperature range. In this way, the main body control circuit 101 can manage the time required to increase the temperature of the belt 50. The main body control circuit 101 enables the heat generation assistance plate 69 to contact with the belt 50 after presuming that the temperature of each section is in a desired temperature range.

Thus, according to the present modification, the same effect as the foregoing embodiment can be achieved. Further, according to the present modification, the main body control circuit 101 can shorten the time required until the fixing apparatus 34 is recovered to a state in which an image can be formed by taking the temperature of the heat generation assistance plate 69 as a reference.

As stated above, the belt 50 of the embodiment has at least the non-magnetic metal layer and a magnetic metal layer. The thickness of the magnetic metal layer is thicker than that of the non-magnetic metal layer. For example, the thickness of the non-magnetic metal layer may be a range from 5 μm to 7 μm. The non-magnetic metal layer may be made of copper. The heat generation layer 50a is an example of the non-magnetic metal layer. The thickness of the magnetic metal layer may be a range from 6 μm to 12 μm. The magnetic metal layer may be made of nickel. The protective layer 50a1 is an example of the magnetic metal layer.

In one embodiment, the thickness of the magnetic metal layer is at least 10% thicker than the thickness of the non-magnetic metal layer. In another embodiment, the thickness of the magnetic metal layer is at least 25% thicker than the thickness of the non-magnetic metal layer. In yet another embodiment, the thickness of the magnetic metal layer is at least 50% thicker than the thickness of the non-magnetic metal layer.

The fixing apparatus 34 of the embodiment has the belt 50. Furthermore, the fixing apparatus 34 may have a magnetic material the Curie temperature of which is from 200 degrees centigrade to 240 degrees centigrade. The magnetic material may have a surface facing the inner peripheral surface of the belt 50. The heat generation assistance plate 69 is an example of the magnetic material.

The belt 50 is formed into layer shape and is formed by arranging the base layer (the base layer 50b), the magnetic metal layer and the non-magnetic metal layer in the order in a direction towards the outer peripheral side from the inner peripheral side of the belt 50. The magnetic material is located on the inner peripheral side with respect to these layers.

In the above embodiment, the IH coil unit 52 is arranged at the outer peripheral side of the belt 50 and is an example of heating the belt 50 from the outer peripheral side. Instead, the IH coil unit 52 may be arranged at the inner peripheral side of the belt 50 to heat the belt 50 from the inner peripheral side. In this case, the IH coil unit 52 may heat a part where the belt 50 contacts with the press roller 51 from the inner peripheral side.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to parameters, measurements, conditions, etc., used in the specification and claims are to be understood as modified in all instances by the term “about.”

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. A fixing belt for an image forming apparatus, comprising:
a non-magnetic metal layer; and
a magnetic metal layer, wherein
a thickness of the magnetic metal layer is at least 10% thicker than a thickness of the non-magnetic metal layer.

2. The fixing belt according to claim 1, wherein
the thickness of the non-magnetic metal layer is in a range from 5 μm to 7 μm.

3. The fixing belt according to claim 1, wherein
the thickness of the magnetic metal layer is in a range from 6 μm to 12 μm.

4. The fixing belt according to claim 1, further comprising a base layer,
wherein the base layer, the magnetic metal layer, and the non-magnetic metal layer are arranged in order from an inner peripheral side towards an outer peripheral side of the fixing belt.

5. The fixing belt according to claim 1, wherein an inner peripheral surface of the fixing belt contacts a magnetic material.

6. (canceled)

7. An image forming apparatus comprising the fixing belt according to claim 1.

8. A fixing apparatus, comprising:
a fixing belt comprising a non-magnetic metal layer and a magnetic metal layer, wherein
a thickness of the magnetic metal layer is at least 10% thicker than a thickness of the non-magnetic metal layer.

9. The fixing apparatus according to claim 8, further comprising
a magnetic material configured to generate heat by receiving magnetic flux and supply the heat to the fixing belt;
a shield arranged along the magnetic material to shield a portion of the magnetic flux; and
a sheet arranged between the shield and the magnetic material.

10. The fixing apparatus according to claim 9, wherein
the sheet comprises a polyimide or an aramid.

11. The fixing apparatus according to claim 8, wherein
the thickness of the non-magnetic metal layer is in a range from 5 μm to 7 μm.

12. The fixing apparatus according to claim 8, wherein
the thickness of the magnetic metal layer is in a range from 6 μm to 12 μm.

13. The fixing apparatus according to claim 9, wherein
a Curie temperature of the magnetic material is from 200 degrees centigrade to 240 degrees centigrade; and
the magnetic material has a surface facing the inner peripheral surface of the fixing belt.

14. (canceled)

15. An image forming apparatus comprising the fixing apparatus according to claim 8.
